(19) United States
(12) Patent Application Publication
(10) Pub. No.: US 2025/0104206 A1
(43) Pub. Date: Mar. 27, 2025

(54) IMAGE CAPTURING SYSTEM AND IMAGE CAPTURING METHOD

(71) Applicant: Mitsubishi Electric Corporation, Tokyo (JP)

(72) Inventor: Kenya NAKAI, Tokyo (JP)

(73) Assignee: Mitsubishi Electric Corporation, Tokyo (JP)

(21) Appl. No.: 18/291,242

(22) PCT Filed: Jul. 29, 2021
(86) PCT No.: PCT/JP2021/028086

§ 371 Date: Jan. 23, 2024

(51) Int. Cl. G06T 7/00; H04N 23/60

(52) U.S. Cl. CPC G06T 7/0002; H04N 23/60; G06T 2207/20021

(57) ABSTRACT

An image capturing system includes an image capturing unit and a processing unit. The image capturing unit includes a first optical adjustment unit to make adjustment of at least one of a focal position and a depth of field of the image capturing unit. The processing unit divides an image capturing visual field of the image capturing unit into a plurality of image capturing regions based on distance information, acquires a plurality of image capturing region images as the background images of the plurality of image capturing regions by having the first optical adjustment unit make the adjustment and having the image capturing unit perform the image capturing of the background surface, and executes the process of detecting the condition of the fluid based on the plurality of image capturing region images.

### TECHNICAL FIELD

The present disclosure relates to an image capturing system and an image capturing method.

### BACKGROUND ART

The PIV (Particle Image Velocimetry) method, the shadow window method and the schlieren method have been known as technologies for visualizing the flow of fluid such as gas or liquid. For example, Non-patent Reference 1 describes a background oriented schlieren (BOS) method in which an image pattern is projected, an image of the projected image pattern is captured by an image capturing unit, and the flow of the fluid existing between the image capturing unit and the image pattern is detected and visualized based on the captured image.

Further, Patent Reference 1 proposes an image capturing system employing a focusing schlieren method using a cutoff filter for an image capturing optical system. This image capturing system corrects the image pattern, as the image to be projected, in order to correct displacement between the cutoff filter and the image pattern that occurs when a background object onto which the image pattern is projected has an uneven surface.

### PRIOR ART REFERENCE

### Non-Patent Reference

Non-patent Reference 1: H. Richard and M. Raffel, “Principle and Applications of the Background Oriented Schlieren (BOS) Method”, Measurement Science and Technology, 12, 1576-1585 (2001)

### Patent Reference

Patent Reference 1: Japanese Patent No. 6796306 (paragraphs 0038-0040, for example)

### SUMMARY OF THE INVENTION

### Problem to be Solved by the Invention

However, even by using the above-described conventional techniques, the flow of the fluid cannot be detected with high accuracy in cases where the shape (e.g., unevenness) of the background object (i.e., background surface) is complicated.

An object of the present disclosure is to provide an image capturing system and an image capturing method with which the flow of the fluid can be detected with high accuracy.

### Means for Solving the Problem

An image capturing system according to the present disclosure includes an image capturing unit to acquire a background image by performing image capturing of a background surface and a processing unit to execute a process of detecting condition of fluid as a detection target existing between the image capturing unit and the background surface. The image capturing unit includes a first optical adjustment unit to make adjustment of at least one of a focal position and a depth of field of the image capturing unit. The processing unit acquires distance information indicating a distance to the background surface, divides an image capturing visual field of the image capturing unit into a plurality of image capturing regions based on the distance information, acquires a plurality of image capturing region images as the background images of the plurality of image capturing regions by having the first optical adjustment unit make the adjustment and having the image capturing unit perform the image capturing of the background surface in regard to each of the plurality of image capturing regions, and executes the process of detecting the condition of the fluid based on the plurality of image capturing region images.

### Effect of the Invention

With the image capturing system and the image capturing method in the present disclosure, the flow of the fluid can be detected with high accuracy.

### BRIEF DESCRIPTION OF THE DRAWINGS

FIG. 1 is a schematic diagram showing an image capturing system according to a first embodiment.

FIGS. 2A to 2D are diagrams showing examples of an image pattern projected by a projection unit.

FIG. 3 is a block diagram schematically showing the configuration of the image capturing system according to the first embodiment.

FIG. 4 is a perspective view showing an example of a background surface onto which the image pattern is projected.

FIG. 5 is a front view showing the background surface in FIG. 4.

FIG. 6 is a plan view schematically showing a positional relationship between an image capturing unit of the image capturing system according to the first embodiment and the background surface in FIG. 4.

FIG. 7 is a plan view schematically showing a plurality of image capturing regions set by a processing unit of the image capturing system according to the first embodiment by dividing an image capturing visual field of the image capturing unit.

FIGS. 8A to 8C are schematic diagrams showing a general relationship between the distance from an image pickup element to a focal point of a lens and a field depth.

FIGS. 9A and 9B are diagrams showing the field depth of an optical system when an aperture diameter of a lens aperture is large and when the aperture diameter of the lens aperture is small.

FIG. 10 is a flowchart showing an image capturing operation for a plurality of image capturing regions in the image capturing system according to the first embodiment.

FIG. 11 is a schematic diagram showing an image capturing system according to a second embodiment.

FIG. 12 is a perspective view showing an example of a background surface onto which the image pattern is projected.

FIG. 13 is a front view showing the background surface in FIG. 12.

FIG. 14 is a block diagram schematically showing the configuration of the image capturing system according to the second embodiment.

FIG. 15 is a diagram showing a result of determining regions differing in the distance to the background surface in the image capturing system according to the second embodiment.

FIG. 16 is a diagram showing a region corresponding to an attention target.

FIG. 17 is a schematic diagram showing another example of the image capturing system according to the second embodiment.

FIG. 18 is a front view showing another example of the image capturing system according to the second embodiment.

FIG. 19 is a diagram showing the background surface in another example of the image capturing system according to the second embodiment and an example of the projected image pattern.

### MODE FOR CARRYING OUT THE INVENTION

An image capturing system and an image capturing method according to each embodiment will be described below with reference to the drawings. The following embodiments are just examples and it is possible to appropriately combine embodiments and appropriately modify each embodiment.

The image capturing system and the image capturing method according to each embodiment are a system and a method based on the background oriented schlieren (BOS) method. The BOS method is a method in which an image pattern is projected, an image of the projected image pattern is captured by an image capturing unit, and the flow of the fluid existing between the image capturing unit and the image pattern is detected and visualized based on the captured image. The image capturing system and the image capturing method according to each embodiment can also be a system and a method based on the PIV or the focusing schlieren method using a cutoff filter.

### First Embodiment

### <Configuration of Image Capturing System>

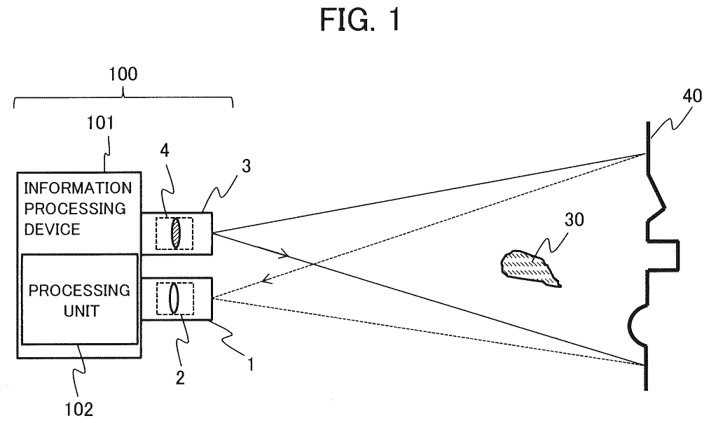

FIG. 1 is a schematic diagram showing an image capturing system 100 according to a first embodiment. As shown in FIG. 1, the image capturing system 100 includes a projection unit 3, an image capturing unit 1 and an information processing device 101. The projection unit 3 projects an image pattern as a projection image onto a background surface 40 as an object. The projection unit 3 is a projector, for example. The projection unit 3 can also be a device separate from the image capturing system 100. The image capturing unit 1 acquires a background image by capturing an image of the image pattern as the projection image projected on the background surface 40. The image capturing unit 1 is a camera, for example. Further, the information processing device 101 is a computer, for example. The information processing device 101 includes a processing unit 102 that executes a process of detecting the flow of the fluid existing between the image capturing unit 1 and the image pattern projected on the background surface 40 as a detection target 30.

The image capturing unit 1 includes a first optical adjustment unit 2 that makes adjustment of at least one of a focal position and a depth of field. The first optical adjustment unit 2 adjusts the focal position, an aperture or a visual field of the image capturing unit 1, for example. The processing unit 102 acquires distance information indicating the distance to the background surface 40, divides an image capturing visual field of the image capturing unit 1 into a plurality of image capturing regions based on the distance information, acquires a plurality of image capturing region images as the background images of the plurality of image capturing regions by having the first optical adjustment unit 2 make the adjustment and having the image capturing unit 1 perform the image capturing of the image pattern in regard to each of the plurality of image capturing regions, and executes the process of detecting the detection target 30 as the flow of the fluid based on the plurality of image capturing region images.

Further, the processing unit 102 may also have a second optical adjustment unit 4 make adjustment in regard to each of the plurality of image capturing regions. The second optical adjustment unit 4 adjusts the focal position, the aperture or the visual field of the projection unit 3, for example. Thanks to the adjustment, the projection unit 3 is capable of setting its focal point (focus) at a certain particular distance L.

The image capturing system 100 detects the detection target 30. The detection target 30 can be, for example, the flow of the fluid, a density gradient of the fluid, and a refractive index gradient of the fluid. These are collectively referred to also as “condition of the fluid”. The flow of the fluid is a flow of gas in a gas (e.g., air flow in air) or a flow of liquid in a liquid. Specifically, the flow of the fluid is a flow of gas in air, a temperature air flow having temperature distribution in air, exhaled air emitted by a person or animal in air, a hot air flow caused in air by metabolism of a body, or the like.

The background surface 40 is situated behind the detection target 30 as viewed from the image capturing unit 1. The background surface 40 is a superficial part of the object to which projection light emitted from the projection unit 3 is applied.

The image capturing system 100 according to the first embodiment is a system based on the BOS method. The image capturing system 100 detects and visualizes (e.g., digitizes into image data) the flow of the fluid. In the detection of the flow of the fluid, the flow of the fluid (e.g., air flow) is visualized by having the projection unit 3 project an image pattern as the reference, having the image capturing unit 1 perform the image capturing of the image pattern, and measuring distortion of the image pattern caused by the density gradient or the refractive index gradient of the fluid existing between the image pattern and the projection device. In cases where the background surface itself has a pattern similar to the image pattern, an image capturing system 100 including no projection unit 3 is also possible.

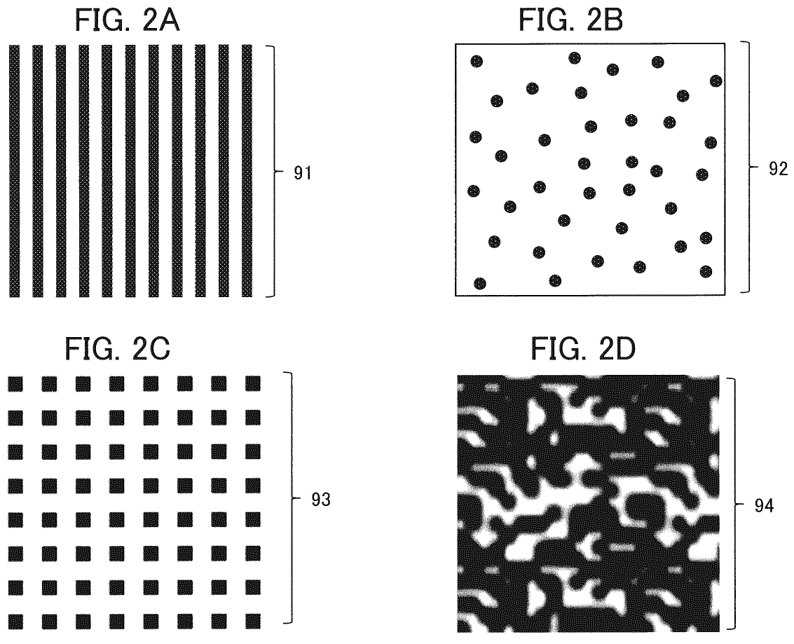

FIGS. 2A to 2D are diagrams showing examples of the image pattern as the projection image projected by the projection unit 3. Image patterns 91-94 are used by the image capturing system 100 for detecting the flow of the fluid. Usable image patterns are not limited to those shown in FIGS. 2A to 2D. Further, usable image patterns are not limited to images formed with black color and white color. The luminance, the shape and the color of the image pattern can be different from those of the illustrated image patterns. Each of FIGS. 2A to 2D shows an image pattern of the light emitted from the projection unit 3. When the image pattern is projected onto a flat (i.e., flat background surface), the projected image is also similar to the pattern shown in each of FIGS. 2A to 2D. That is, while the image pattern acquired by the image capturing unit 1 is an image based on the image pattern shown in each of FIGS. 2A to 2D, the acquired image pattern has been deformed depending on the position and the shape of the background surface. In a case where the background surface is an object's surface not flat but having unevenness, the captured image of the image pattern acquired by the image capturing unit 1 changes due to influence of the shape of the background surface.

The projection unit 3 of the image capturing system 100 according to the first embodiment projects an image generated by the processing unit 102 onto the background surface 40. In this case, it is also possible to perform the image projection by using light in a wavelength band invisible to the human eye (e.g., infrared light or light with a longer wavelength). This method prevents the projection light from causing dazzlement to a human or an animal. However, the wavelength of the projected light is not limited to the aforementioned wavelength band. The projected light can also be visible light or light in the ultraviolet region at a shorter wavelength compared to the visible light.

The image capturing unit 1 captures an image of the image projected on the background surface 40 through the flowing fluid by the BOS method. The flowing fluid is, for example, gas flowing in air, a temperature air flow having temperature distribution, a hot air flow as exhalation, or the like. The first optical adjustment unit 2 includes a lens for adjusting the focal point (focus) of the image capturing unit 1, and has a function of making adjustment for clearly photographing the image on the background surface 40 by a method like making optical axis adjustment of the lens.

The second optical adjustment unit 4 includes a lens for adjusting the focus of the projection unit 3, and has a function of making adjustment for clearly projecting the image on the background surface 40 by a method like making optical axis adjustment of the lens.

Each of first and second lens optical axis adjustment units includes, for example, a mechanism capable of making adjustment so that the focal point of the lens is situated at a position at a particular distance by moving the lens itself in the optical axis direction. However, the lens optical axis adjustment unit can also be a unit that electrically changes the refractive index of the lens material without moving the lens in the optical axis direction or a unit employing a different focus control method.

The image capturing unit 1 includes an image pickup element 1a employing CCD (Charge Coupled Device), CMOS (Complementary Metal Oxide Semiconductor) or the like, for example.

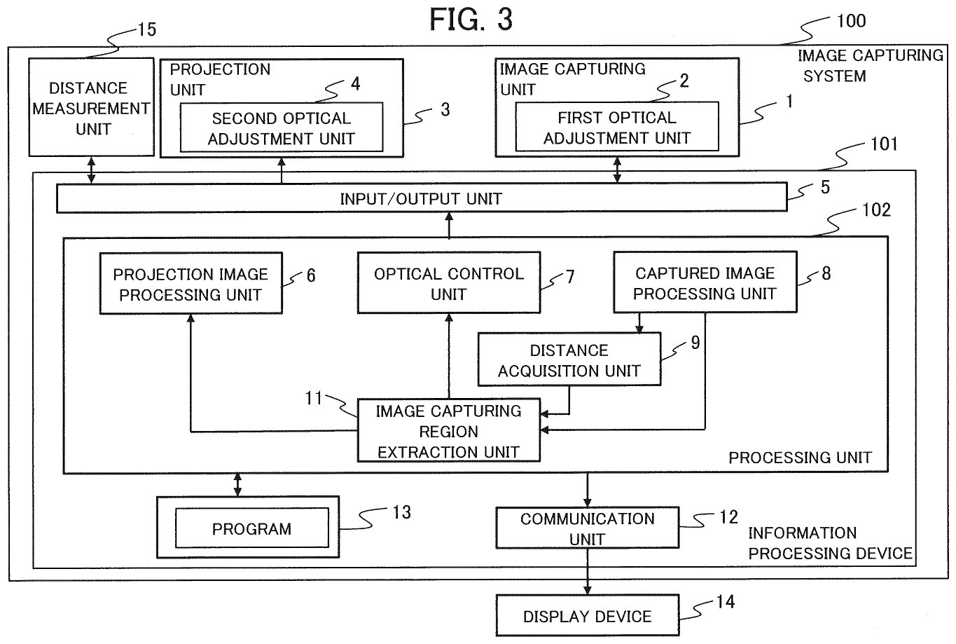

FIG. 3 is a block diagram schematically showing the configuration of the image capturing system 100. The image capturing system 100 is capable of executing an image capturing method according to the embodiment. The image capturing system 100 can include the components shown in FIG. 3. The image capturing system 100 in FIG. 3 includes the projection unit 3, the image capturing unit 1 and the information processing device 101. Further, while the image capturing system 100 in FIG. 3 includes a distance measurement unit 15 for measuring the distance to an object, the image capturing system 100 can be without the distance measurement unit 15 in cases where a distance acquisition unit 9 is capable of acquiring the distance. Furthermore, a display device 14 is connected to the image capturing system 100 via a communication unit 12.

The information processing device 101 controls the operation and input/output of each part of the image capturing system 100. The processing unit 102 is in charge of various processes using the image captured by the image capturing unit 1 and various processes regarding the image to be projected by the projection unit 3. The information processing device 101 includes an input/output unit 5 and the processing unit 102. The processing unit 102 includes a projection image processing unit 6, an optical control unit 7, a captured image processing unit 8, the distance acquisition unit 9 and an image capturing region extraction unit 11.

The processing unit 102 controls the operation of the projection unit 3 and the image capturing unit 1 via the input/output unit 5. The projection image processing unit 6 generates pattern data and luminance data of the image pattern as the projection image of the projection unit 3. The optical control unit 7 adjusts the focal distance of the first optical adjustment unit 2 and the focal distance of the second optical adjustment unit 4 by controlling the position of the lens of the first optical adjustment unit 2 in the optical axis direction and the position of the lens of the second optical adjustment unit 4 in the optical axis direction. The captured image processing unit 8 processes the image captured by the image capturing unit 1. The captured image processing unit 8 has a function of detecting the flow of the fluid in the acquired image and visualizing (i.e., digitizing into image data) the flow of the fluid. The image data is displayed by the display device 14, for example.

The distance acquisition unit 9 acquires the distance information indicating the distance from the image capturing unit 1 to the background surface 40. The distance acquisition unit 9 acquires the distance information indicating the distance to the background surface 40 and shape information indicating the shape of the background surface 40.

For example, the distance acquisition unit 9 may be configured to acquire distance information measured by a distance measurement sensor provided outside the image capturing system 100. Alternatively, the distance acquisition unit 9 can have a function of calculating or estimating the distance information from deformation of the captured image in the captured image processing unit 8 caused by the unevenness of the background surface 40. In this case, it is unnecessary to provide the distance measurement sensor outside the image capturing system 100 and a simple configuration can be realized.

The image capturing region extraction unit 11 determines an image capturing region, as a region regarded as an image capturing target in the image capturing visual field of the image capturing unit 1, by using the distance information acquired by the distance acquisition unit 9 and the image data obtained by the captured image processing unit 8. Further, the image capturing region extraction unit 11 can also have a function of determining an image capturing order of image capturing regions when there exist a plurality of image capturing regions.

### <Explanation of Background Surface 40>

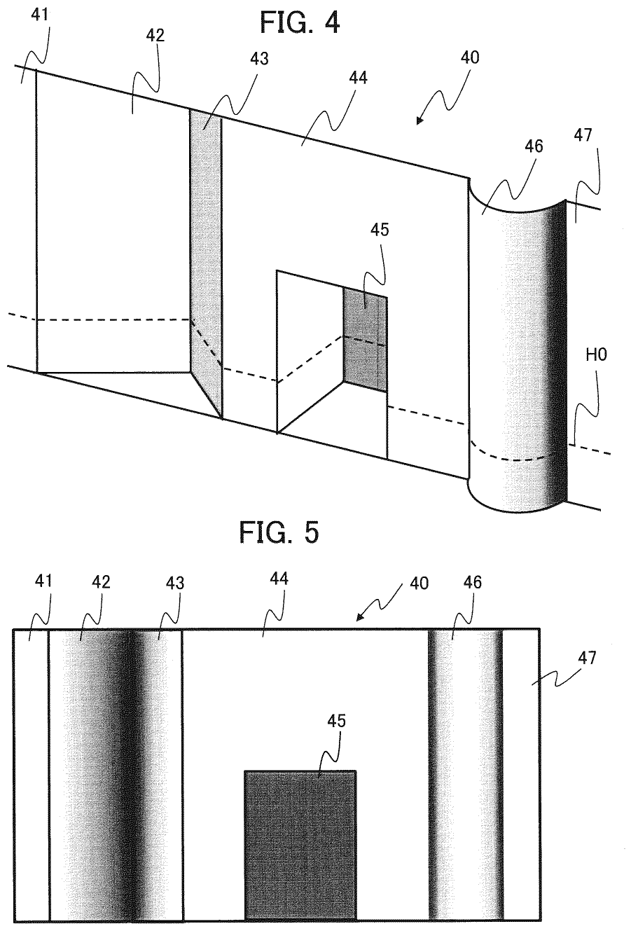

FIG. 4 is a perspective view showing an example of the background surface 40 onto which the image pattern is projected. FIG. 5 is a front view showing the background surface 40 in FIG. 4. The background surface 40 includes uneven regions. The unevenness can include an inclined surface and a curved surface. As shown in FIG. 4 and FIG. 5, the background surface 40 is made up of surfaces 41 to 47.

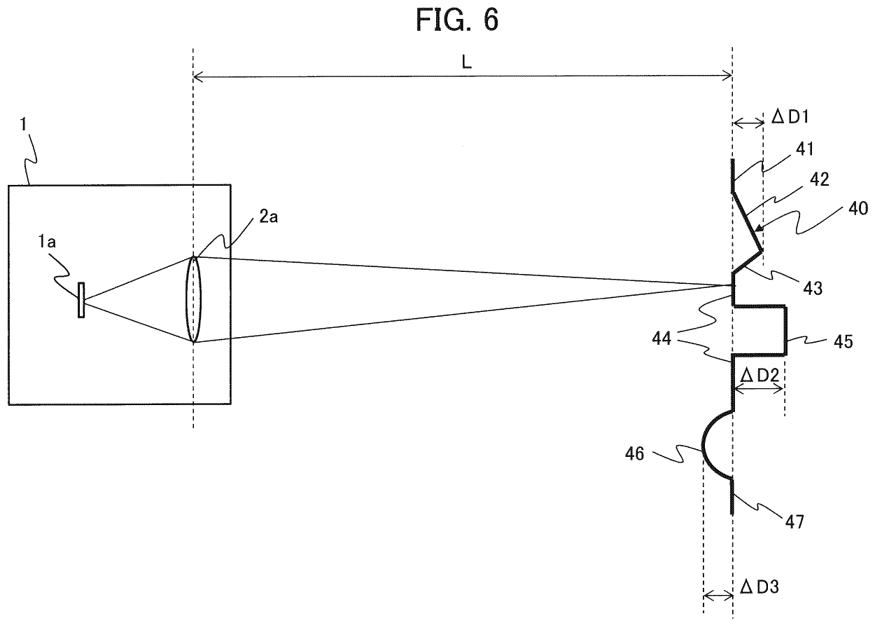

FIG. 6 is a plan view schematically showing a positional relationship between the image capturing unit 1 of the image capturing system 100 and the background surface 40 in FIG. 4. FIG. 6 shows a lens 2a of the first optical adjustment unit 2 and the image pickup element 1a. Further, FIG. 6 shows a depth shape of the background surface 40 at a height H0 position indicated by the broken line in FIG. 4. FIG. 6 indicates the distance L from the lens 2a to the surfaces 41, 44 and 47 of the background surface 40. The surfaces 41, 44 and 47 are flat surfaces. The surfaces 41 and 42 form a concave surface that is inclined with respect to the optical axis of the projection unit 3, and the maximum depth of the concave surface is ΔD1. The surface 45 is a concave surface whose depth is ΔD2. The surface 46 is formed as a convex surface having a curved surface with a depth of ΔD3. The example shown in FIG. 6 is an uneven shape just for explanation; the shape of the background surface 40 is not limited to the illustrated example.

The image capturing unit 1 is capable of adjusting the focal point (focus) of the image capturing optical system by a method such as moving the lens forward/backward in the optical axis direction. The description here is given of an example in which the focus can be adjusted to every one of distance ranges of the surfaces 41 to 47.

### Explanation of Conventional Problem

Next, a description will be given of a conventional problem that can occur when the background surface 40 has unevenness.

When the image pattern is projected onto the background surface 40, there are cases where the background surface 40 is not a simple plane but in an uneven shape as shown in FIG. 6. For example, if the image capturing unit 1 sets its focus at the particular distance L (on the surface 44 in this example), defocusing occurs in the background surface's regions situated at positions farther than the distance L, and the captured image pattern becomes unclear. When the image pattern is unclear, measurement accuracy of the distortion of the image pattern deteriorates and it becomes impossible to detect the flow of the fluid with high accuracy. In measurement methods based on the schlieren method, the distortion of the captured image of the background has to be detected with high accuracy, and thus the level of the resolution of the captured image or the level of the definition of the image pattern is a factor highly relevant to the measurement accuracy. Thus, in order to detect the flow of the fluid with high accuracy, the image pattern on the background surface 40 has to be captured more clearly.

To eliminate such a defocusing problem, it is also possible to consider a method in which a user installs a new background surface as a flat surface equidistant from the image capturing system 100; however, there is great restriction in use.

Further, in regard to an image capturing system based on the focusing schlieren method using a cutoff filter, the Patent Reference 1 describes a technique of modifying the image pattern or the pattern of the cutoff filter as a countermeasure against the problem that the displacement of the projected image pattern from the pattern of the cutoff filter occurs when there is an uneven background surface. However, in reality, it is difficult to simultaneously set the focus on a plurality of surfaces at different depth positions, and thus the detection accuracy of the flow of the fluid is necessitated to be sacrificed even if the captured image of the image pattern is acquired successfully. Therefore, with the image capturing system described in the Patent Reference 1, it is difficult to detect the flow of the fluid with high accuracy throughout the whole of the image capturing visual field.

To resolve the above-described problem, the image capturing system 100 according to the first embodiment includes a means that extracts or determines an image capturing target region (referred to also as the “image capturing region”), as the image capturing target in the image capturing visual field, based on the distance information regarding the background surface 40 with respect to the image capturing system (or the shape information regarding the background surface) and a means that executes optical control of selectively or efficiently performing the focus control in regard to the extracted or determined image capturing region.

With the image capturing system 100 according to the first embodiment, it is possible to detect the flow of the fluid with high accuracy throughout the whole of the image capturing visual field even in cases of using a background surface having unevenness (e.g., the background surface 40) commonly existing in a general environment. Further, the user is relieved of the need of installing a flat screen, and in addition, restriction on the arrangement of the image capturing system 100 due to the shape of the background surface can be lightened or eliminated.

### <Operation of Image Capturing System>

The image capturing system 100 in the first embodiment acquires the distance information regarding the distance between the image capturing system 100 and the background surface 40, namely, the distance information regarding the surfaces 41 to 47 due to the shape of the background surface 40 having unevenness, sets a plurality of image capturing regions regarded as image capturing targets based on the distance information, and makes it possible to detect the flow of the fluid with high accuracy throughout the whole of the image capturing visual field while selectively switching these image capturing regions.

When the focal point is set at a certain distance L by using the lens 2a of the image capturing unit 1, there exists a field depth h that is determined by specifications of the lens or the like in the vicinity of the focal point. In general, the field depth is a distance range on the subject's side (i.e., the background surface 40's side) that looks focused, and means a range in which the image can be considered to be formed sufficiently clearly. In a range within the field depth from the focal point, the projected image is captured with substantially no degradation. However, when the distance to the background surface is great beyond the field depth, the defocusing has occurred, and thus it is evident that focus correction is effective also for the detection of the flow of the fluid.

Further, in the flow of the fluid such as exhalation, a temperature air flow or minute gas leakage, in cases of a detection target whose density gradient or refractive index gradient is small, the detection of the flow of the fluid is difficult by using the generic field depth as the criterion, and thus it is necessary to detect the flow of the fluid with high accuracy. In this case, it is effective to detect a change at the level of so-called subpixels, which are smaller than the pixel of the image pickup element 1a. For this purpose, it is effective to set the focus in a range narrower than the field depth and reduce the degradation of the captured image as much as possible. Therefore, in the image capturing system 100 according to the first embodiment, a coefficient as is introduced into the field depth of the image capturing unit 1 and the product (αs×hs) of the coefficient αs and the field depth hs is set as the focus range.

In the first embodiment, a plurality of image capturing regions regarded as the image capturing targets are set based on the field depth of the image capturing unit 1 and the distance information, and the detection of the flow of the fluid is carried out while dynamically switching these image capturing regions.

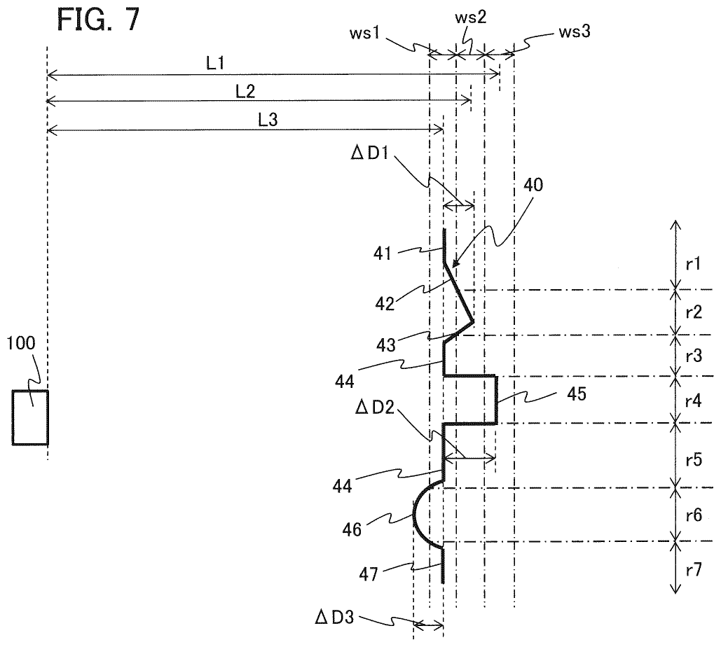

FIG. 7 is a diagram for explaining a method of setting the plurality of regions regarded as the image capturing targets based on the field depth of the image capturing unit 1 and the distance information in regard to the background surface 40 having unevenness. The explanation here is given with reference to the flat surfaces 41, 44 and 47 at the same distance L1 from the image capturing system 100.

Further, the focus of the image capturing unit 1 has been adjusted to a position at the distance L1. In the example of FIG. 7, the depths ΔD1, ΔD2 and ΔD3 are assumed to be greater than the field depth hs1 in the state in which the focus has been adjusted to the position at the distance L1. In this case, in regard to a region r1, a region r3, a region r5 and a region r7 of the background surface 40 that are included in a focus range ws1=(αs1×hs1) in the depth direction centering at the position at the distance L1, the flow of the fluid can be detected with high accuracy since the regions r1, r3, r5 and r7 are within the focus range ws1. Therefore, these regions are set as the image capturing targets, the detection of the flow of the fluid is carried out by using the captured images of these regions, and detection results of the flow of the fluid in regard to the other regions are not adopted.

Next, when the focus of the image capturing unit 1 is adjusted to a position at a distance L2, the field depth is h2. There exists a range of the field depth hs2 in the depth direction centering at the position at the distance L2. In this case, a region r2 of the background surface 40, included in a focus range ws2=(αs2×hs2) in the depth direction centering at the position at the distance L2, is in the focus range ws2, and thus the flow of the fluid can be detected with high accuracy in regard to the region r2.

The distance L2 can be set so that the focus range ws1 and the focus range ws2 are continuous with each other in regard to the depth direction. Here, the focus range ws1 and the focus range ws2 do not necessarily need to have the continuity and it is also possible to set these ranges to have an overlap with each other or to be separate from each other. Thus, the region r2 is set as the image capturing target, the detection of the flow of the fluid is carried out by using the captured image of the region r2, and detection results of the flow of the fluid in regard to the other regions are not adopted.

Next, when the focus of the image capturing unit 1 is adjusted to a position at a distance L3, the field depth is hs3. There exists a range of the field depth hs3 in the depth direction centering at the position at the distance L3. In this case, a region r4 of the background surface 40, included in a focus range ws3=(αs3×hs3) in the depth direction centering at the position at the distance L3, is in the focus range ws3, and thus the flow of the fluid can be detected with high accuracy in regard to the region r4.

The distance L3 can be set so that the focus range ws2 and the focus range ws3 are continuous with each other in regard to the depth direction. Here, the focus range ws2 and the focus range ws3 do not necessarily need to have the continuity and it is also possible to set these ranges to have an overlap with each other or to be separate from each other. Thus, the region r4 is set as the image capturing target, the detection of the flow of the fluid is carried out by using the captured image of the region r4, and detection results of the flow of the fluid in regard to the other regions are not adopted.

By successively adjusting the focal position of the image capturing unit 1 as above, it is possible to inhibit the defocusing of the image capturing unit 1 caused by the unevenness of the background surface 40 and carry out the detection of the flow of the fluid with high accuracy throughout the whole of the image capturing visual field.

Further, the distance information regarding the image capturing system 100 and the background surface 40, namely, the distance information regarding the surfaces 41 to 47 due to the shape of the background surface 40 having unevenness, can be acquired by the distance acquisition unit 9. A plurality of regions regarded as the image capturing targets are set based on the distance information, these regions are switched dynamically, and the detection of the flow of the fluid is carried out with high accuracy throughout the whole of the image capturing visual field.

In general environments. there are many cases where the unevenness of the background surface 40 in the depth direction is greater than the focus range ws=(αs×hs) corresponding to the field depth hs. In the state in which the image capturing unit 1 has set its focus at a certain distance, the defocusing occurs in the background surface 40's regions situated outside the focus range ws and the detection of the flow of the fluid is difficult.

By acquiring the distance information as described above, a target value for correcting the defocusing of the image capturing unit 1 can be set.

Thus, thanks to the above-described configuration and its functions, the image capturing system 100 according to the first embodiment has an advantage in that it becomes possible to detect the flow of the fluid with high accuracy throughout the whole of the image capturing visual field even when the background surface 40 having unevenness is used.

### <Focus Adjustment of Projection Unit>

Next, a description will be given of the projection unit 3 as a characteristic feature of the first embodiment and optical adjustment made by the projection unit 3 for realizing the high-accuracy detection of the flow of the fluid.

In the above explanation using FIG. 1 to FIG. 7, the description is given of the feature of detecting the flow of the fluid with high accuracy throughout the whole of the image capturing visual field by selectively making the focus correction in regard to the defocusing of the image capturing unit 1 occurring when the background surface 40 has unevenness.

In order to detect the flow of the fluid with still higher accuracy, it is also important to maintain the image pattern on the background surface 40 displayed by the projection unit 3, at high definition. If the defocusing (pattern blurring) has occurred to the image pattern on the background surface 40, the captured image acquired by the image capturing unit 1 loses contours therein and it becomes impossible to efficiently detect the distortion caused by the flow of the fluid. That is, just modifying the image pattern image as in the image capturing system according to the Patent Reference 1 cannot remove the defocusing (pattern blurring) and it becomes impossible to detect the flow of the fluid with high accuracy.

Therefore, in the image capturing system 100 according to the first embodiment, the projection unit 3 includes the second optical adjustment unit 4. The image capturing system 100 carries out the detection of the flow of the fluid while selectively switching the image capturing targets among the plurality of surfaces of the uneven background surface 40 at different distances in regard to the focus correction made by the second optical adjustment unit 4.

The detection of the flow of the fluid in the image capturing targets can be carried out with high accuracy by making the second optical adjustment unit 4 of the projection unit 3 operate to focus and form an image on the region on the background surface selected as the image capturing targets of the image capturing unit 1.

Thus, the most desirable state is a state in which each of the first optical adjustment unit 2 and the second optical adjustment unit 4 operates so that the image capturing unit 1 and the projection unit 3 simultaneously focus on the same image capturing target. However, the focus of the image capturing unit 1 and the focus of the projection unit 3 do not necessarily have to perfectly coincide with each other. For example, it is permissible if the focal position of each unit 1, 3 is in the focus range wt=(αt×ht) of the projection unit 3 in consideration of the coefficient at for the field depth ht of each unit. This is because the degradation of the contours in the captured image due to the defocusing is negligibly small and thus the detection of the flow of the fluid can be carried out with high accuracy if the focal position of each unit 1, 3 is in the focus range wt.

### <Adjustment of Field Depth by Aperture Adjustment>

The image capturing unit 1 and the projection unit 3 may have a function of making aperture adjustment in addition to the above-described focus adjustment of the image capturing unit 1 and the projection unit 3 or instead of the focus adjustment of the projection unit 3.

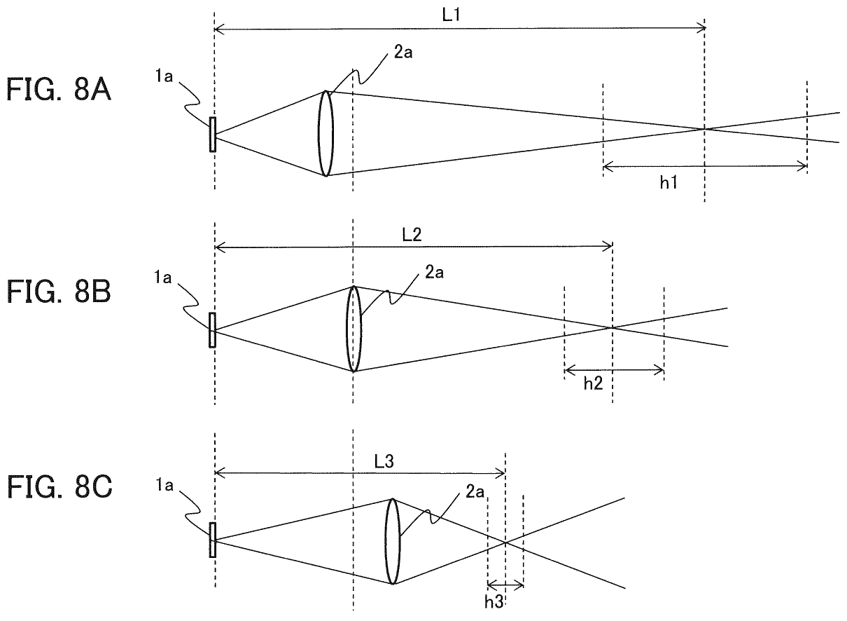

When the distance L from the image pickup element 1a to the focal point changes, the field depth changes depending on each focus adjustment state (i.e., the distance L). FIGS. 8A to 8C are diagrams schematically showing a general relationship between the distance L from the image pickup element 1a to the focal point and the field depth. As the distance L becomes longer as shown in FIG. 8A, the field depth h tends to increase. Conversely, as the distance L becomes shorter as shown in FIG. 8B and FIG. 8C, the field depth h tends to decrease.

Therefore, the image capturing region extraction unit 11 may appropriately modify set values of the field depths hs and ht or the coefficients as and at depending on the distance from the image capturing system 100 to each image capturing region of the background surface 40 due to the unevenness of the background surface 40. This reduces the quality degradation of the image pattern or the background of the captured image of each image capturing region and makes it possible to secure high detection accuracy of the flow of the fluid in comparison with cases where the field depths hs and ht or the coefficients αs and αt are set at constant values.

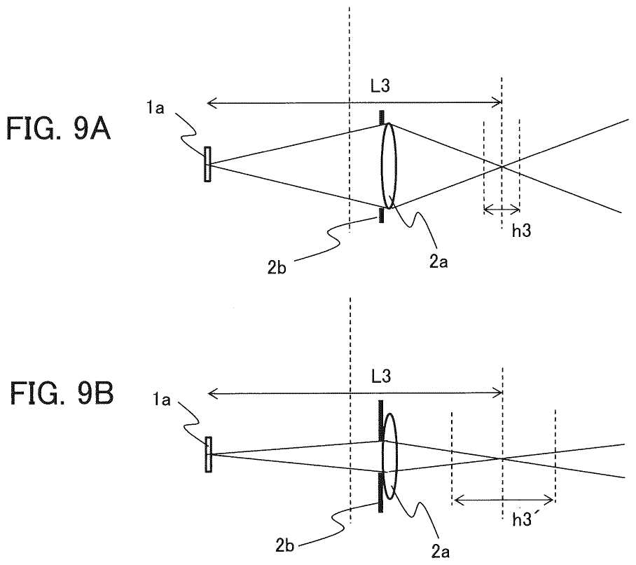

Further, each of the first optical adjustment unit 2 and the second optical adjustment unit 4 may be provided with a function of adjusting the lens aperture so as to limit the visual field of the image capturing unit 1 and the visual field of the projection unit 3 to each image capturing region after the extraction of the plurality of image capturing regions. FIGS. 9A and 9B are diagrams showing the relationship between the varying lens aperture and the field depth h of an optical system. When the lens aperture is set large as shown in 9B, the field depth h can be enlarged compared to cases where the lens aperture is small as shown in 9A.

That is, the focus range ws=(αs×hs) and the focus range wt=(αt×hs) can be enlarged by adjusting the lens apertures to suit the image capturing region. This increases the likelihood of the optical adjustment made by the first optical adjustment unit 2 of the image capturing unit 1 and the second optical adjustment unit 4 of the projection unit 3, and thus an advantage is obtained in that the adjustment time can be shortened, for example.

While the above explanation has been given of a case where the background surface 40 includes a surface inclined with respect to the image capturing system 100 like the background surface 40 shown in FIG. 6 and FIG. 7, when the surfaces 41 to 47 can be judged to be surfaces with no inclination and substantially orthogonal with respect to the image capturing system 100, the distance information regarding the surfaces 41 to 47 means that the surfaces 41 to 47 serve exactly as image capturing regions and the first optical adjustment unit 2 and the second optical adjustment unit 4 can be controlled so as to set the focus at the distance value of each of the surfaces 41 to 47.

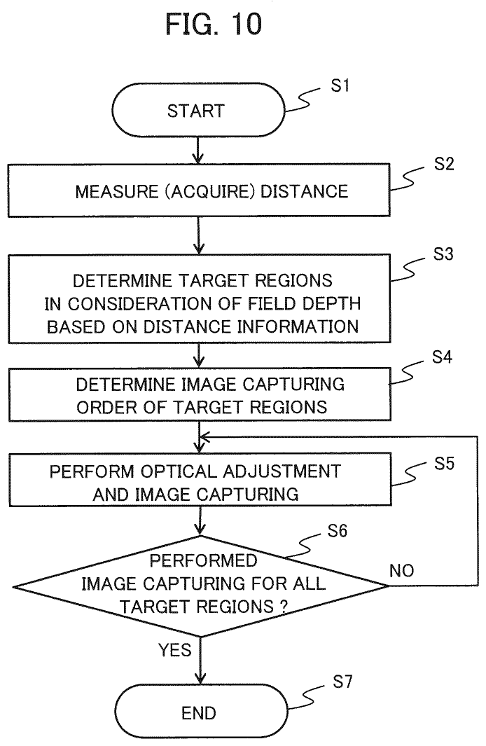

FIG. 10 is a flowchart showing an image capturing operation for a plurality of image capturing regions in the image capturing system 100 according to the first embodiment. This flowchart is a flowchart from the start of the acquisition of the distance information to the optical adjustment made by the first optical adjustment unit 2 and the second optical adjustment unit 4 and the image capturing operation. The operation after the image capturing operation is left out here. The operation shown in the flowchart will be explained below.

In step S1, the processing unit 102 starts the image capturing system 100's operation for detecting the flow of the fluid. In step S2, due to the startup of the operation, the distance acquisition unit 9 of the processing unit 102 acquires the distance information regarding the distance to the background surface 40 having unevenness. In step S3, the image capturing region extraction unit 11 of the processing unit 102 determines the image capturing regions in consideration of the field depth based on the distance information. In step S4, the image capturing region extraction unit 11 of the processing unit 102 determines the image capturing order regarding the image capturing regions based on the distance information. In step S5, for an image capturing region selected based on the image capturing order, the processing unit 102 makes the optical adjustment of the first optical adjustment unit 2 of the image capturing unit 1 and the second optical adjustment unit 4 of the projection unit 3, namely, makes the adjustment of the focuses and the lens apertures. The image capturing is performed after the optical adjustment is completed.

In step S6, the processing unit 102 judges whether or not the image capturing has been performed for all of the image capturing regions determined by the image capturing region extraction unit 11, advances the process to step S7, i.e., END if the image capturing has been completed for all of the image capturing regions, and advances the process to the step S5 if there remains an image capturing region for which the image capturing has not been completed. Thanks to the step S6, it is possible to detect the flow of the fluid with high accuracy in a wide region made up of the plurality of image capturing regions as the image capturing targets, without leaving an unacquired image capturing region. In the step S7, the process ends. In reality, a process step of converting or estimating detection values of the flow of the fluid and a process step of converting the flow of the fluid into a visualized image are carried out. Further, there can be cases where a process different from the above-described process is executed.

The above-described flowchart just shows an operation example of the image capturing system 100, and thus it is permissible even if other steps are added or the order of the steps is changed.

As described above, the image capturing system 100 according to the first embodiment divides into a plurality of different image capturing regions based on the distance information regarding the background surface, performs the image capturing for each image capturing region respectively in a desirable optical adjustment state, and is consequently capable of detecting the flow of the fluid with high accuracy in a wide visual field.

The image capturing system 100 described above is a system assumed to include the projection unit 3 and the projection image processing unit 6 and project the image pattern onto the background surface 40. In this case, there is an advantage in that the background surface 40 does not need to be particularly provided with the image pattern and the degree of freedom of the setting of the image pattern is high.

However, the image capturing system 100 is not limited to such a system assumed to include the projection unit 3 and the projection image processing unit 6 and project the image pattern onto the background surface 40. For example, the projection unit 3 and the projection image processing unit 6 can be left out in cases where the background surface 40 itself has a pattern thereon and in cases where a variety of physical phenomenon (e.g., moire, scattering or speckles) appearing on the surface due to minute unevenness or distortion is practically usable similarly to the image pattern used in the schlieren method, for example.

### Second Embodiment

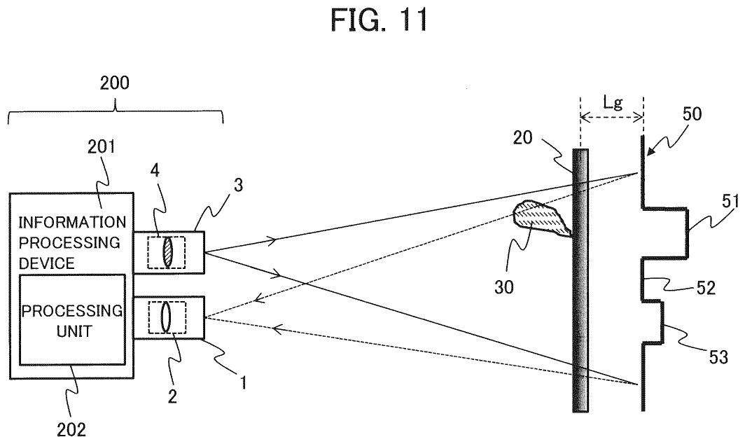

FIG. 11 is a schematic diagram showing an image capturing system 200 according to a second embodiment. In the following description, each element identical or corresponding to an element of the image capturing system 100 according to the first embodiment is assigned the same reference character as in the first embodiment and explanation thereof is omitted or simplified.

The image capturing system 100 according to the first embodiment extracts the image capturing regions based on the distance information regarding the background surface 40. In contrast, the image capturing system 200 according to the second embodiment extracts or determines the image capturing regions by using an estimation result of an attention target 20 and distance information regarding the distance to the attention target 20 so that the detection target 30 can be detected efficiently and promptly. Further, the image capturing system 200 according to the second embodiment estimates the distance to the detection target (i.e., the flow of the fluid) based on the distance information regarding the attention target and corrects the measurement value of the detection target (i.e., the flow of the fluid) based on the estimated distance to the detection target.

In the image capturing system 200 shown in FIG. 11, the attention target 20 is added to the image capturing system 100 according to the first embodiment shown in FIG. 1. The attention target 20 is an object caused by the occurrence of the detection target 30 or an object having some kind of causal relationship with the occurrence of the detection target 30. Further, being an object existing around (i.e., in the vicinity of) the detection target 30 may be regarded as one example of the causal relationship. For example, in cases where gas leaking out from gas piping is defined as the detection target 30, the attention target 20 is the gas piping. That is, since the gas leakage is leakage occurring at the gas piping, the possibility that the gas leakage has occurred is considered to be low in a region in the image capturing visual field that is sufficiently separate from the gas piping, and the region can be judged to have little causal relationship with the detection target 30. Therefore, the region . . . can be excluded from the regions to be captured by the image capturing system 100, or the order of priority for image capturing can be raised in regard to regions having a stronger causal relationship than the separate region. Such a means has an advantage in that the detection target 30 can be detected promptly. Here, if a certain type of linking or association has previously been made to the object caused by the occurrence of the detection target 30 or the object having some kind of causal relationship with the occurrence of the detection target 30, it is unnecessary that a direct occurrence factor or a direct physical causal relationship be actually satisfied.

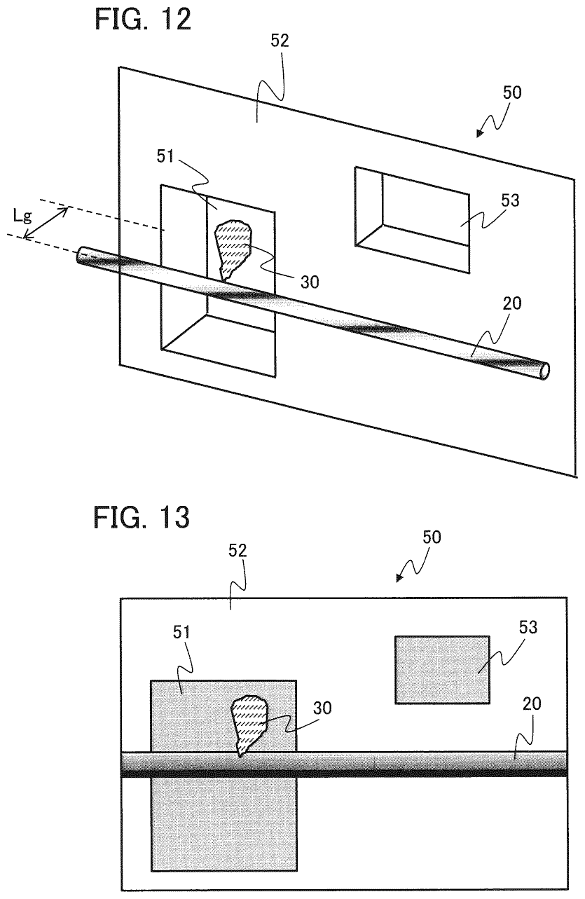

The operation in the second embodiment will be described concretely below. FIG. 12 and FIG. 13 are respectively a front view of a background surface 50 viewed from a projection side and a perspective view showing an example of the background surface 40 having unevenness. They schematically show a state in which the background surface 50 includes regions in uneven shapes and gas piping as the attention target 20 exists in front of the background surface 50. In this example, the background surface 50 is in a shape including a region 51, a region 52 and a region 53 respectively at three different distances. The gas piping as the attention target 20 is arranged at a position that is separate from the region 52 of the background surface 50 towards the image capturing system 200's side by a distance Lg. The shape of the gas piping in FIG. 12 and FIG. 13 is simplified for the sake of the explanation of the second embodiment. The shape of the gas piping is not limited to the illustrated shape; piping in a complicated shape extending in a variety of direction like a vertical direction or an oblique direction may be arranged.

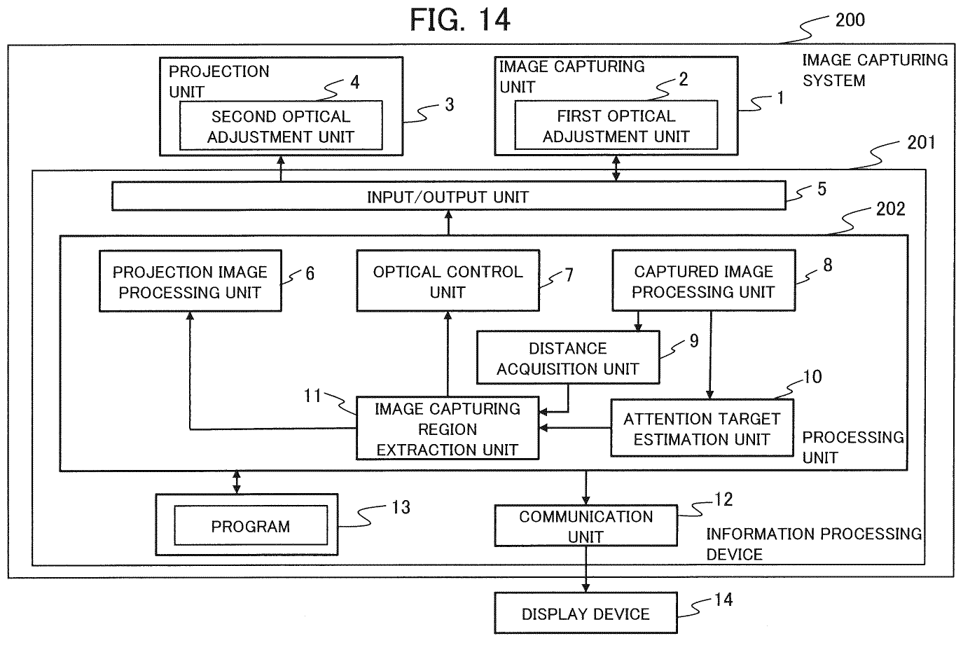

FIG. 14 is a block diagram schematically showing the configuration of the image capturing system 200 according to the second embodiment. The image capturing system 200 according to the second embodiment differs from the image capturing system 100 according to the first embodiment in that a processing unit 202 of an information processing device 201 includes an attention target estimation unit 10. Except for this feature, the second embodiment is the same as the first embodiment.

The attention target estimation unit 10 estimates the attention target 20 or a particular region around the attention target 20 from the captured images based on the captured image processing unit 8, and estimates the position of the estimated attention target 20 or particular region. The attention target 20 can be estimated by using a generic object detection technique such as an object detection technique employing AI (artificial intelligence) technology. Based on the captured images, whether an object estimated from the captured images matches a previously registered attention target 20 or not is judged based on the shape, size, color, relationship with an image captured around the object, or the like, and the result of the judgment is outputted as the estimation result. As such a previously registered attention target 20, an object having some kind of causal relationship with the detection target 30 is previously set.

Similarly to the first embodiment, a plurality of image capturing regions are extracted based on the distance information.

Accordingly, by preferentially performing the image capturing on the attention target 20 and particular image capturing regions around the attention target 20, the probability that the detection target 30 is included in the image capturing region can be made high and the gas leakage can be detected promptly.

A description will be given below of an operation of determining the image capturing regions based on the distance information regarding the background surface 60 and the estimation result of the attention target. Similarly to the first embodiment, the distance information regarding the background surface 60 in the image capturing visual field is acquired by the distance acquisition unit 9.

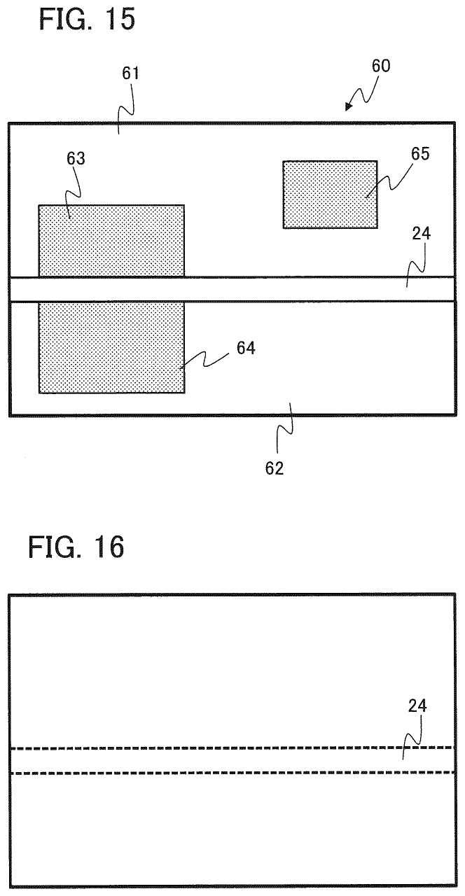

FIG. 15 is a diagram showing a result of determining image capturing regions differing in the distance determined based on the distance of the background surface 40 acquired by the distance acquisition unit 9. In this case, it has been divided into five regions: an image capturing region 63 and an image capturing region 64, an image capturing region 61 and an image capturing region 62, and an image capturing region 65. Further, an attention region 24 is a region corresponding to the gas piping as the attention target 20. The process so far is the same as the process executed by the distance acquisition unit 9 and the image capturing region extraction unit 11 in the first embodiment.

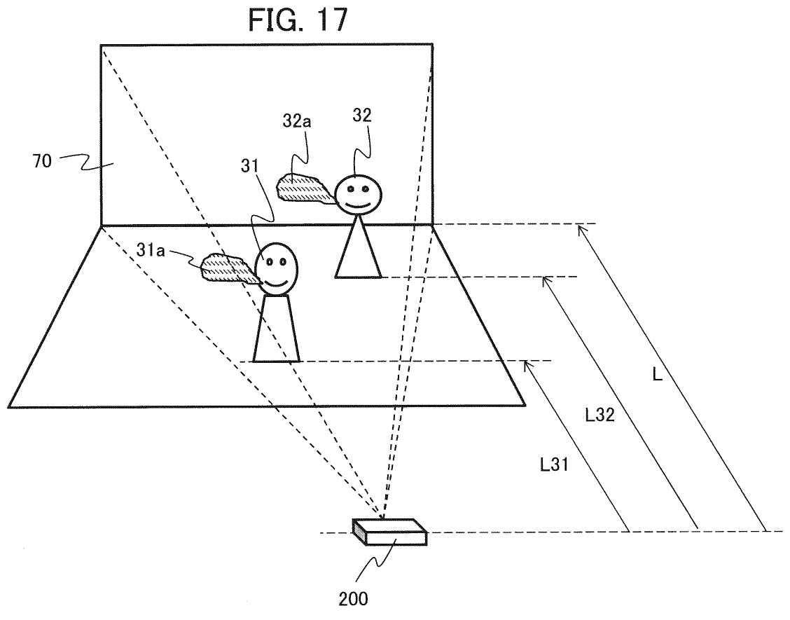

Subsequently, the attention target estimation unit 10 estimates the attention target 20 or a particular region around the attention target 20 from the captured images based on the captured image processing unit 8, and estimates the position of the estimated attention target 20 or particular region. FIG. 16 is a diagram showing the attention region 24 that is estimated as the gas piping by the attention target estimation unit 10 and thus corresponds to the attention target 20.

The image capturing region extraction unit 11 is capable of determining the image capturing regions out of the attention region 24, the image capturing region 65, the image capturing region 63, the image capturing region 64, the image capturing region 61 and the image capturing region 62 based on the distance information acquired by the distance acquisition unit 9 so that a processing time of the focal distance adjustment or the lens aperture adjustment for actually performing the image capturing becomes short. For example, if the distance to the image capturing region 63 and the image capturing region 64 is L63, the distance to the image capturing region 61 and the image capturing region 62 is L61, the distance to the image capturing region 65 is L65, and these distances satisfy a magnitude relationship of L63>L65>L61>Lg, the processing unit 202 makes the image capturing unit perform the image capturing in the order of “L63”, “L65”, “L61” and “Lg” as a descending (monotonically decreasing) order of the distance, or in the order of “Lg”, “L61”, “L65” and “L63” as an ascending (monotonically increasing) order of the distance.

That is, the processing unit 202 makes the image capturing unit 1 perform the image capturing in the order of “the image capturing region 63 and the image capturing region 64”, “the image capturing region 65”, “the image capturing region 61 and the image capturing region 62”, and “the attention region 24”, or in the order of “the attention region 24”, “the image capturing region 61 and the image capturing region 62”, “the image capturing region 65”, and “the image capturing region 63 and the image capturing region 64”.

This shortens the processing time of the lens focus adjustment performed by the first optical adjustment unit 2 and the second optical adjustment unit 4.

Further, the image capturing region extraction unit 11 is capable of limiting the image capturing regions or changing the priority order regarding the image capturing order based on the position where the attention target 20 is situated as the estimation result of the attention target estimation unit 10. For example, it is possible to perform the image capturing while limiting the image capturing regions to the attention region 24 and regions adjoining the attention region 24. The method of limiting the image capturing regions is not limited to the above-described method; various combinations of methods are possible, such as limiting the image capturing regions to the attention region 24 alone.

This shortens the processing time of the lens focus adjustment performed by the first optical adjustment unit 2 and the second optical adjustment unit 4 or the time it takes for the image capturing, and the gas occurrence position can be located promptly, for example.

When the specific gravity of the gas leaking out from the gas piping is greater than the specific gravity of ambient gas existing around the leaking gas, the leaking gas tends to flow downward relative to the gas piping as the attention target 20. Conversely, when the specific gravity of the leaking gas is less than the specific gravity of the ambient gas, the leaking gas tends to flow upward relative to the gas piping. Therefore, the image capturing region extraction unit 11 may perform the setting of the image capturing priority order or the limitation of the image capturing regions in regard to the image capturing region 63 and the image capturing region 61 situated above the attention region 24 or the image capturing region 64 and the image capturing region 62 situated below the attention region 24 among the image capturing regions adjoining the attention region 24 by using relevant information such as the specific gravity of the gas as the detection target 30.

Further, in cases where there exist a plurality of attention targets 20 differing in the level of the causal relationship with the detection target 30, it is also possible to previously set the magnitude (magnitude relationship) of the causal relationship level in regard to the plurality of attention targets 20 and perform the setting of the image capturing priority order or the limitation of the image capturing regions based on the magnitude relationship.

This reduces process steps of the lens focus adjustment performed by the first optical adjustment unit 2 and the second optical adjustment unit 4 or shortens the time required for the image capturing, and the gas occurrence position can be located promptly.

Further, the projection image processing unit 6 generates a pattern in which the projection image is limited to the image capturing regions, by which the electric power consumed by the light source of the projection unit 3 can be reduced.

While the above description of the image capturing system has been given of the cases where the density gradient or the refractive index gradient based on the schlieren method is detected, the image capturing system does not need to be limited to such cases. For example, the image capturing system can also be an image capturing system based on PIV. For instance, in such an image capturing system based on PIV, at least the image capturing unit 1 is capable of making the adjustment so as to focus on the attention target 20 that has been set to have the causal relationship with the detection target 30. That is, by focusing on the attention target 20, it is possible to approximately focus also on the detection target 30 situated in the vicinity of the attention target 20, by which scattered light from fine particles for visualization used in PIV can be efficiently guided to the image capturing unit 1. As above, also in the case of the image capturing system based on PIV, it is possible to determine the attention region and the image capturing regions and perform the setting of the image capturing priority order or the limitation of the image capturing regions by using the distance information regarding the distance to the attention target 20. There is an advantage in that the occurrence position or the depth direction of the flow of the fluid can be determined and visualized promptly.

As described above, the image capturing system 200 and the image capturing method according to the second embodiment includes a means that estimates an attention target 20 caused by the occurrence of the detection target 30 or having some kind of causal relationship with the occurrence of the detection target 30 and determines the image capturing regions based on the result of the estimation, by which an advantage is obtained in that the detection target 30 can be detected promptly.

### (Modification)

Next, modifications of the second embodiment will be described below. A means similar to the above-described means can be employed not only in cases of detecting the gas leakage from gas piping but also in cases where there exists such an attention target 20 having the causal relationship with the detection target 30. For example, when the detection target 30 is exhalation from a person, the attention target 20 can be defined as a human's face or a human's mouth or nose. These are parts having a strong causal relationship with the occurrence of the exhalation, and are used for estimating the position of the exhalation or the distance to the exhalation.

When the attention target 20 is a part of a human body as above, it is desirable to prevent the light emitted from the projection unit 3 from being applied to the human body or the part of the human body. For example, the image capturing system 200 can be provided with a function of reducing or zeroing out the luminance in regard to a region corresponding to a human's face.

FIG. 17 is a diagram for explaining the image capturing system 200 for detecting the exhalation from a plurality of humans. A person 31 and a person 32 are respectively situated at positions at a distance L31 and a distance L32 from the image capturing system 200, exhalation 31a and exhalation 32a respectively from the person 31 and the person 32 occur, and each of the exhalation 31a and the exhalation 32a is a detection target.

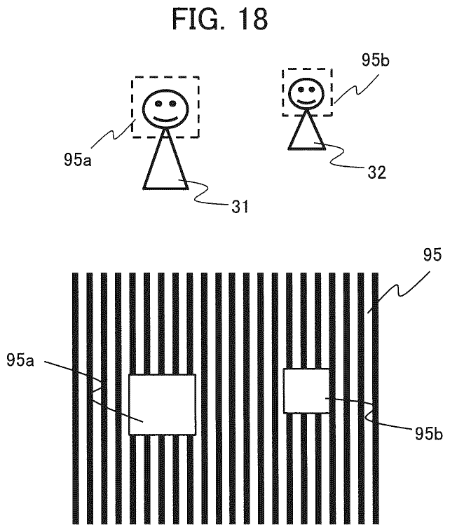

FIG. 18 is a front view for explaining the image capturing system 200 for detecting the exhalation from a plurality of humans, and is a diagram viewing the background surface in FIG. 17 in front from the image capturing system 200's side. The image capturing region extraction unit 11 estimates the person 31 and the person 32 being the attention targets, and sets light irradiation exclusion regions 95a and 95b respectively in the vicinity of the faces of the person 31 and the person 32. Based on the light irradiation exclusion regions 95a and 95b, the projection image processing unit 6 zeros out or lowers the luminance of light in regard to regions in the image pattern corresponding to the exclusion regions 95a and 95b.

With the configuration in which the projection image processing unit 6 generates an image pattern in which the luminance of light is zero or low in the vicinity of each eye or face and the projection unit 3 projects the image pattern onto a background surface 70, an advantage of not dazzling a human is obtained when visible light being visible to the human eye is used. On the other hand, even though the problem of dazzling a human does not occur when infrared light or light at a still longer wavelength being invisible to the human eye is used, this configuration is effective in meeting the need to avoid exposure of a human body or a part of a human body, such as an eye, to light.

The captured image processing unit 8 also has a function of converting the captured images into image data for visualizing the flow of the fluid. The captured image processing unit 8 can also have a function of converting the image data into a physical quantity such as the flow rate or the speed of the fluid. In cases where the image capturing system 200 is a system based on the BOS method, the density gradient of gas, the refractive index gradient of gas or the like is the detection value. In general, the detection value such as the density gradient of gas, the refractive index gradient of gas or the like is converted into a physical quantity such as the flow rate or the speed of the fluid.

However, due to the principle of the BOS method, the detection value varies even for the density gradient or the refractive index gradient of the same detection target 30 depending on the distance between the background surface 70 and the detection target 30. In reality, the detection value tends to increase with the increase in the distance Lp (not shown) from the background surface 70 to the detection target 30.

In the modification of the second embodiment, the image capturing system can be provided with a function of correcting the detection value depending on the aforementioned distance Lp from the background surface 70 to the detection target 30. The distance Lp may be obtained by using the distance information acquired by the distance acquisition unit 9, and the aforementioned correction of the detection value is possible. The detection value can be a value based on an approximating numerical expression such as a linear function or a quadratic or higher order function with respect to the distance Lp, an exponential function, a logarithmic function, or the like. Further, the use of such a numerical expression is not necessarily essential; it is also possible to make the correction of the detection value based on a previously set contrast table of correction values with respect to the distance Lp.

### <Correction of Image Pattern>

Next, a description will be given of a function of modifying the image pattern based on the distance information regarding the background surface 70.

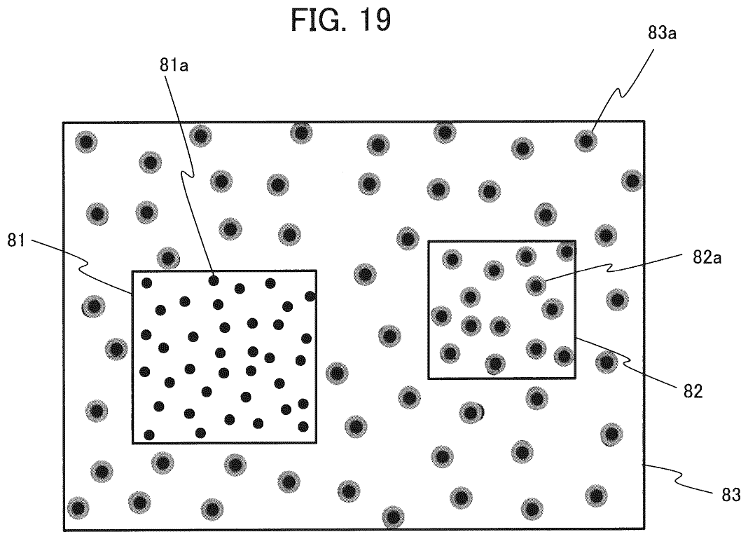

FIG. 19 is a diagram showing another example of the background surface 70 having unevenness and the projected image pattern. Here, the image pattern is the random circular dot pattern (hereinafter referred to as a dot pattern) shown in FIG. 2B, for example. However, the image pattern can also be an image pattern of a different type. For simplicity of explanation, the explanation here will be given of an example in which there is a background surface 70 in which there exist three image capturing regions 81, 82 and 83 differing in the distance. Let La, Lb and Lc respectively represent the distances from the image capturing system 200 to the image capturing region 81, the image capturing region 82 and the image capturing region 83, a relationship La<Lb<Lc holds.

FIG. 19 shows a state in which the focus of the second optical adjustment unit 4 of the projection unit 3 is set at the distance La of the image capturing region 81 and the defocusing occurs to the image capturing region 82 and the image capturing region 83 depending on the distance.

In the following, consideration will be given to pattern density of each image pattern when the optical adjustment unit 4 makes the adjustment to focus on one of the image capturing region 81, the image capturing region 82 and the image capturing region 83 each time. When the projection image processing unit 6 does not make the modification of the pattern in the focus control, optical magnification of the projected image pattern increases proportionally to the distance according to the distance relationship La<Lb<Lc, and a projection area also increases. Therefore, let Da, Db and Dc respectively represent the pattern densities of the image capturing region 81, the image capturing region 82 and the image capturing region 83, Da>Db>Dc holds. Upon the occurrence of such a variation in the pattern density, the density of the dot pattern at the position of the detection target 30 varies and the number of dot patterns used for visualizing the density gradient or the refractive index gradient of the detection target 30 varies from image capturing region to image capturing region. Accordingly, there occurs difference in the detection value of the density gradient or the refractive index gradient.

To avoid the above-described problem, the projection image processing unit 6 is capable of correcting the projection image so that the pattern densities of the image pattern projected on the image capturing region 81, the image capturing region 82 and the image capturing region 83 become equal or equivalent to each other by generating projection images differing in the pattern density respectively for the image capturing region 81, the image capturing region 82 and the image capturing region 83. Alternatively, it is also possible for the projection image processing unit 6 to make the correction of the pattern density depending on a magnitude relationship with a predetermined pattern density reference value.

By this correction, even when the background surface 70 has unevenness, the background dot pattern density becomes equal or equivalent to each other in the visualization of the density gradient or the refractive index gradient of the detection target 30 and the error in the detection value of the density gradient or the refractive index gradient at the background surface 70 having unevenness can be reduced to a minimum.

The above description has been given of a case where the detection target 30 is exhalation, this is just an example and the detection target 30 is not limited to exhalation. For example, the detection target 30 can also be a gas flow, a hot air flow, or a fluid being not gas but liquid, and the attention target 20 can be replaced with a variety of object such as gas piping or an air-conditioning heating-cooling product emitting a hot air flow.

Further, while the schlieren method, especially the BOS method, is employed as an example in the above description of the image capturing systems according to the first embodiment and the second embodiment, the employed method is not limited to the schlieren method. It is also possible to employ a modified type of the schlieren method, such as the focusing schlieren method using a cutoff filter, for example.

Furthermore, the means for dividing the image capturing visual field into a plurality of image capturing regions and selectively detecting or visualizing the flow of the fluid, which is employed by the image capturing systems according to the first embodiment and the second embodiment, may be applied also to image capturing systems including the image capturing unit and the projection unit as components and detecting or visualizing the flow of the fluid by use of the PIV method, the shadow window method or the like.

Moreover, the above-described image capturing systems according to the first embodiment and the second embodiment can have a function of generating a visualization image of the flow of the fluid from the images respectively acquired in the image capturing regions. Further, the image capturing systems can have a function of connecting together the visualization images respectively generated in regard to the image capturing regions and thereby generating one wide-range visualization image of the flow of the fluid in regard to not only a single image capturing region but also a plurality of image capturing regions connected together. In this case, it is difficult to instantaneously acquire the captured images of the same time in regard to the image capturing regions since the focus control or the aperture control by the first optical adjustment unit 2 and the second optical adjustment unit 4 and a process related to the image acquisition have to be executed for capturing each image. Thus, in cases where the direction of the flow of the detection target changes rapidly, there is a possibility that a connection part in the aforementioned connected visualization image is discontinuous. In such cases, the image capturing system can be provided with a function of explicitly indicating each image capturing region in the visualization image and explicitly indicating time information with which the acquisition time of each captured image or the shift in the acquisition time can be grasped. In contrast, in cases where there is no major change in the flow of the detection target, a continuous visualization image is obtained in regard to the aforementioned connection part.

With this function, it is possible to provide one wide-range visualization image of the flow of the fluid in regard to a plurality of image capturing regions connected together.

Further, while the above description of the image capturing systems has been given mainly on the assumption that the detection target 30 is the flow of fluid, the detection target 30 is not limited to the flow of fluid but can also be an air flow in air (namely, a flow of air in air), for example. In cases where the flow is in liquid, the detection target 30 can be the flow of liquid or solution. In cases where the detection target 30 is the flow of fluid, the detection target 30 can be any one out of fluid (gas, a temperature air flow having temperature distribution, or the like) in air, exhalation from a human or an animal, a hot air flow caused by metabolism of a body, and so forth.

### (Hardware Configuration)

An example of the hardware configuration of the image capturing system 100 according to the first embodiment and the image capturing system 200 according to the second embodiment will be described below.

The processing unit 102, 202 of the information processing device 101, 201 can be either dedicated hardware or a processor that executes a program stored in a memory 13.

In cases where the processing unit 102, 202 is dedicated hardware, the processing unit 102, 202 is, for example, a single circuit, a combined circuit, a programmed processor, a parallelly programmed processor, an ASIC (Application Specific Integrated Circuit), an FPGA (Field-Programmable Gate Array) or a combination of some of these circuits. Functional units included in the information processing device 101, 201 may be either implemented respectively by separate processing circuitry or implemented by single processing circuitry.

For example, the information processing device 101, 201 includes a processor and a memory. The processor implements the operation of the functional units by reading out and executing a program stored in the memory. The memory stores the program according to which the processes of the functional units are consequently carried out when the program is executed by the processor. The program stored in the memory is a program that causes a computer to execute a procedure or a method of the functional units.

The processor is, for example, a CPU (Central Processing Unit), a processing device, an arithmetic device, a microprocessor, a microcomputer, a DSP (Digital Signal Processor) or the like. The memory is, for example, a nonvolatile or volatile semiconductor memory such as a RAM (Random Access Memory), a ROM (Read Only Memory), a flash memory, an EPROM (Erasable Programmable Read Only Memory) or an EEPROM (Electrically Erasable Programmable Read Only Memory), a magnetic disk, a flexible disk, an optical disc, a compact disc, a DVD (Digital Versatile Disc), or the like. The program stored in the memory is software, firmware, or a combination of software and firmware.

The image capturing systems according to the first and second embodiments and their modifications (hereinafter referred to simply as “above-described embodiments”) may be modified appropriately. For example, modification, addition or removal of a component can be made to the image capturing systems according to the above-described embodiments. Further, features or components of the above-described embodiments may be appropriately combined together in a mode different from the above-described modes.

### INDUSTRIAL APPLICABILITY

The image capturing systems according to the above-described embodiments are applicable to various industrial fields. For example, the image capturing systems are applicable to a gas leakage detection device, a human/animal exhalation detection device, a driver monitor system (DMS) for detecting physical condition of a passenger of a vehicle or the like by detecting exhalation from the passenger, an air flow detection device, a temperature air flow detection device for detecting warm air or cool air from an air-conditioning device such as an air conditioner or an air-conditioning control device for an air-conditioning device employing the temperature air flow detection device, a refrigerant leakage detection device for an air-conditioning device or the like, a detection device for detecting foreign matter in liquid, an inspection device in regard to heterogeneity or a defect in a solid-state material such as a semiconductor, a striae examination device for optical components or the like, and so forth. Employing such detection devices according to the above-described embodiments enables more desirable control and maintenance of equipment.

### DESCRIPTION OF REFERENCE CHARACTERS

1: image capturing unit, 1a: image pickup element, 2: first optical adjustment unit, 2a: lens, 2b: aperture, 3: projection unit, 4: second optical adjustment unit, 4a: lens, 4b: aperture, 5: input/output unit, 6: projection image processing unit, 7: optical control unit, 8: captured image processing unit, 9: distance acquisition unit, 10: attention target estimation unit, 11: image capturing region extraction unit, 12: communication unit, 13: memory, 14: display device, 15: distance measurement unit, 30: detection target, 31, 32: person, 31a, 32a: exhalation, 40, 50, 60, 70: background surface, 41, 44, 47: surface (plane part), 42, 43: surface (inclined part), 45: surface (concave part), 46: surface (convex part), 51-53: region, 61-65: image capturing region, 81-83: image capturing region, 81a: focused pattern, 82a, 83a: defocused pattern, 91-94: image pattern, 95: image pattern, 95a, 95b: exclusion region, 100, 200: image capturing system, 101, 201: information processing device, 102, 202: processing unit.

1. An image capturing system, comprising:
an image capturer to acquire a background image by performing image capturing of a background surface; and
processing circuitry to execute a process of detecting condition of fluid as a detection target existing between the image capturer and the background surface, wherein
the image capturer includes a first optical adjustment unit to make adjustment of at least one of a focal position and a depth of field of the image capturer, and
the processing circuitry
divides an image capturing visual field of the image capturer into a plurality of image capturing regions based on distance information indicating a distance to the background surface,
acquires a plurality of image capturing region images as the background images of the plurality of image capturing regions by having the first optical adjustment unit make the adjustment and having the image capturer perform the image capturing of the background surface in regard to all or part of the plurality of image capturing regions, and
executes the process of detecting the condition of the fluid based on the plurality of image capturing region images.

2. The image capturing system according to claim 1, wherein the processing circuitry executes a process of detecting at least one of a flow of the fluid, a density gradient of the fluid, and a refractive index gradient of the fluid as the condition of the fluid.

3. The image capturing system according to claim 1, wherein the processing circuitry divides the image capturing visual field into the plurality of image capturing regions based on the distance from the image capturer to the background surface.

4. The image capturing system according to claim 1, wherein the processing circuitry includes:
distance acquisition circuitry to acquire the distance information based on the background image acquired by the image capturer.

5. The image capturing system according to claim 1, further comprising:
distance detector to measure the distance,
wherein the processing circuitry acquires the distance information based on the distance acquired by the distance detector.

6. The image capturing system according to claim 1, wherein:
the processing circuitry determines an image capturing order of the plurality of image capturing regions based on a magnitude relationship among the distances of the plurality of image capturing regions.

7. The image capturing system according to claim 1, wherein:
the processing circuitry determines an image capturing order of the plurality of image capturing regions in descending order or ascending order of the distance in regard to the plurality of image capturing regions.

8. The image capturing system according to claim 1, further comprising:
a projector to project a projection image onto the background surface.

9. The image capturing system according to claim 8, wherein:
the processing circuitry includes projection image processing circuitry to generate the projection image.

10. The image capturing system according to claim 8, wherein:
light of the projection image projected from the projector is light at an invisible wavelength.

11. The image capturing system according to claim 8, wherein:
the processing circuitry modifies an image pattern included in the projection image based on a result of a comparison between density of the image pattern included in the projection image in each of the plurality of image capturing regions and a predetermined reference value.

12. The image capturing system according to claim 8, wherein the processing circuitry generates a pattern for image capturing regions onto which the image pattern included in the projection image is projected among the plurality of image capturing regions.

13. The image capturing system according to claim 8, wherein:
the processing circuitry further includes an attention target estimation circuitry to estimate an attention target having a relationship with the detection target from the captured images, and
the processing circuitry extracts image capturing regions onto which the image pattern is projected from among the plurality of image capturing regions based on magnitude of an occurrence frequency of the detection target estimated depending on at least one of a type, a shape and a positional relationship of the attention target estimated by the attention target estimation circuitry.

14. The image capturing system according to claim 1, wherein:
when there exists an undetected region for which the detection has not been carried out yet among the plurality of image capturing regions in the image capturing visual field, the processing circuitry determines the undetected region as a next image capturing region.

15. The image capturing system according to claim 4, further comprising:
a projector to project a projection image onto the background surface,
wherein the projector projects both a projection image for distance measurement to be used when the distance acquisition circuitry acquires the distance information and a projection image projected towards the image capturing regions.

16. The image capturing system according to claim 4, wherein:
the distance acquisition circuitry converts distortion variation of a projection image acquired by the image capturer with respect to a reference image into a value of the distance information regarding each image capturing region.

17. The image capturing system according to claim 13, wherein the processing circuitry:
detects an eye region of a person in the captured images, and
prevents an image from being projected onto the detected eye region of the person or lowers intensity of an image projected onto the eye region of the person.

18. The image capturing system according to claim 1, wherein:
as an image of the condition of the fluid as the detection target in the plurality of image capturing regions, the processing circuitry generates at least one of an image connecting a flow of the fluid, an image connecting a density gradient of the fluid, and an image connecting a refractive index gradient of the fluid.

19. An image capturing method, comprising:
dividing an image capturing visual field into a plurality of image capturing regions based on distance information indicating a distance to a background surface;
acquiring a plurality of image capturing region images as background images of the plurality of image capturing regions by making an optical adjustment of at least one of a focal position and a depth of field and performing image capturing of the background surface in regard to all or part of the plurality of image capturing regions; and
detecting a condition of the fluid based on the plurality of image capturing region images.
